(19) United States
(12) Patent Application Publication
(10) Pub. No.: US 2008/0315510 A1
(43) Pub. Date: Dec. 25, 2008

(54) ALIGNMENT DEVICE FOR USE WITH A BOOK BINDER

(76) Inventors: Cary Brzinski, Hartland, WI (US); Calvin L. Wade, Waukesha, WI (US)

Correspondence Address: MICHAEL BEST & FRIEDRICH LLP, 100 E WISCONSIN AVENUE, Suite 3300, MILWAUKEE, WI, 53202, US

(21) Appl. No.: 12/142,868

(22) Filed: Jun. 20, 2008

Related U.S. Application Data
(60) Provisional application No. 60/945,768, filed on Jun. 22, 2007.

(51) Int. Cl. B65H 9/16; B42C 9/02; B42C 11/00

(52) U.S. Cl. 271/250; 412/6; 412/4

(57) ABSTRACT

An alignment device for substantially aligning a plurality of signatures of a book block comprising a projection and an actuator coupled to the projection. The actuator may be actuable to move the projection within a path of the book block such that the projection contacts an edge of at least one of the plurality of signatures and positions the at least one of the plurality of signatures into substantial alignment with the other signatures of the book block.

### CROSS-REFERENCE TO RELATED APPLICATIONS

This application claims priority to U.S. Provisional Patent Application No. 60/945,768, filed Jun. 22, 2007, the entire contents of which are hereby incorporated by reference.

### BACKGROUND

The present invention relates to a book binder.

Typically, a book binder includes a gathering section to align staggered signatures (e.g., pages, postcards, flyers, etc.) of a book block. As a book block is conveyed through the gathering section, the book block may pass over joggers which facilitate alignment of the signatures by jogging the book block. However, the joggers may be insufficient to align all of the signatures, leaving some signatures to protrude past the leading edge of the book block. Having a signature that protrudes from the book block may cause a false registration that the book block is too large, resulting in rejection. Other problems may include improper or excessive trimming of the book block or one or more signatures within the book block. Salvaging a rejected book block by rerunning the book block through the book binder can be costly and time consuming. Extra trimming can alter the centering of, or even cutoff, text or pictures in the book block, resulting in poor quality book blocks or waste.

### SUMMARY

In one embodiment, provided is an alignment device for substantially aligning a plurality of signatures of a book block. The alignment device comprises a projection and an actuator coupled to the projection. The actuator may be actuable to move the projection within a path of the book block such that the projection contacts an edge of at least one of the plurality of signatures and positions the at least one of the plurality of signatures into substantial alignment with the other signatures of the book block. The projection may further contact an edge of at least one of a plurality of signatures without stopping along the path.

In another embodiment, provided is a system for assembling a book block including a plurality of signatures. The system comprises a conveyor configured to convey the book block along a path and an alignment device including a projection and an actuator coupled to the projection. The actuator may be actuable to move the projection within the path such that the projection contacts an edge of at least one of the plurality of signatures and position the at least one of the plurality of signatures into substantial alignment with the other signatures of the book block.

In yet another embodiment, provided is a method of substantially aligning a plurality of signatures of a book block using an alignment device. The alignment device comprises a projection and an actuator coupled to the projection. The method comprises conveying the book block along a path, moving the projection within the path with the actuator, and contacting an edge of at least one of the plurality of signatures with the projection when the projection is within the path. The method may also comprise positioning the at least one of the plurality of signatures into substantial alignment with the other signatures of the book block as the projection contacts the edge of the at least one of the plurality of signatures.

In still another embodiment, provided is a method of substantially aligning a plurality of signatures of a book block. The method comprises conveying the book block along a path at a first speed, moving a projection within the path at a second speed, and contacting an edge of at least one of the plurality of signatures with the projection when the projection is within the path. The method may also comprise positioning the at least one of the plurality of signatures into substantial alignment with the other signatures of the book block as the projection contacts the edge of the at least one of the plurality of signatures. The method may further comprise moving the projection within the path in the same direction as the book block is conveyed.

It can be appreciated in all embodiments described herein that the projection of the alignment device may move the at least one of a plurality of signatures of a book block to more closely align the signatures within the book block with positive pressure being applied to the at least one of a plurality of signatures of a book block by either moving the projection in the direction opposite to the path of travel of the book block or, alternatively, moving the projection in the same direction of the path of movement of the book block but at a slower or reduced speed than the book block.

Other aspects of the invention will become apparent by consideration of the detailed description and accompanying drawings.

### BRIEF DESCRIPTION OF THE DRAWINGS

FIG. 1 is a perspective view of an alignment device according to one embodiment of the invention.

FIG. 2 is a top view of the alignment device shown in FIG. 1.

FIG. 3 is a front view of the alignment device shown in FIG. 1.

FIG. 4 is a side view of the alignment device shown in FIG. 1.

FIG. 5 is a perspective view of one embodiment of a book binder including the alignment device shown in FIG. 1.

FIGS. 6A and 6B are perspective views of a back portion of the book binder shown in FIG. 5.

FIGS. 7A and 7B are schematic side and top views, respectively, of the alignment device of FIG. 1 and a book block in a first position.

FIGS. 8A and 8B are schematic side and top views, respectively, of the alignment device of FIG. 1 and the book block in a second position.

FIGS. 9A and 9B are schematic side and top views, respectively, of the alignment device of FIG. 1 and the book block in a third position.

FIGS. 10-13 are various views of a portion of the book binder and the alignment device shown in FIG. 5 with a book block.

FIG. 14 is a schematic view of another embodiment of an alignment device according to another embodiment of the invention.

FIG. 15 is an enlarged cross-section taken along line 15-15 in FIG. 14.

### DETAILED DESCRIPTION

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways. Also, it is to be understood that the phraseology and terminology used herein are for the purpose of description and should not be regarded as limiting. The use of “including,” “comprising,” or “having” and variations thereof herein is meant to encompass the items listed thereafter and equivalents thereof as well as additional items. Unless specified or limited otherwise, the terms “mounted,” “connected,” “supported,” and “coupled” and variations thereof are used broadly and encompass both direct and indirect mountings, connections, supports, and couplings. Further, “connected” and “coupled” are not restricted to physical or mechanical connections or couplings.

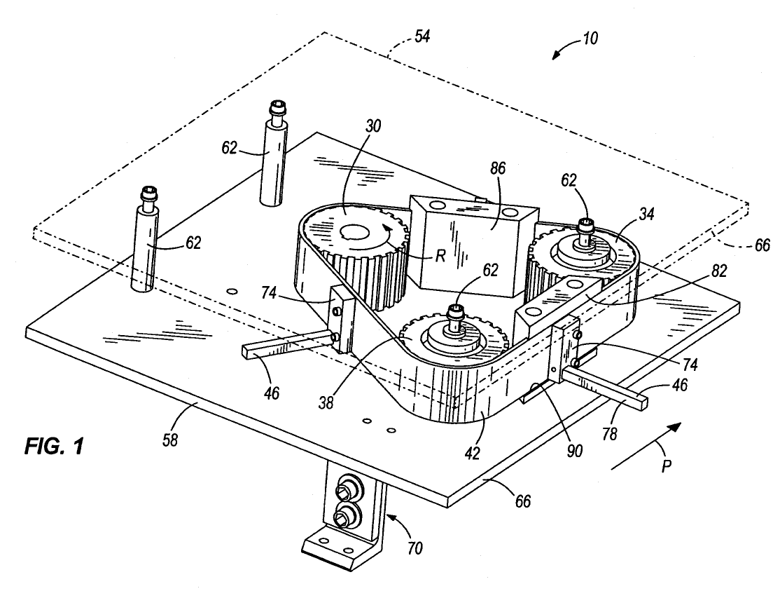

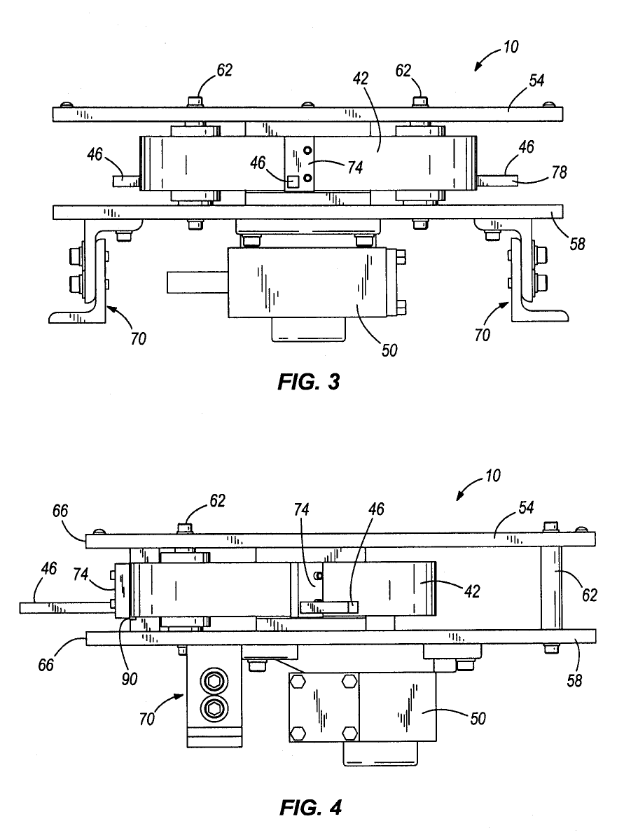

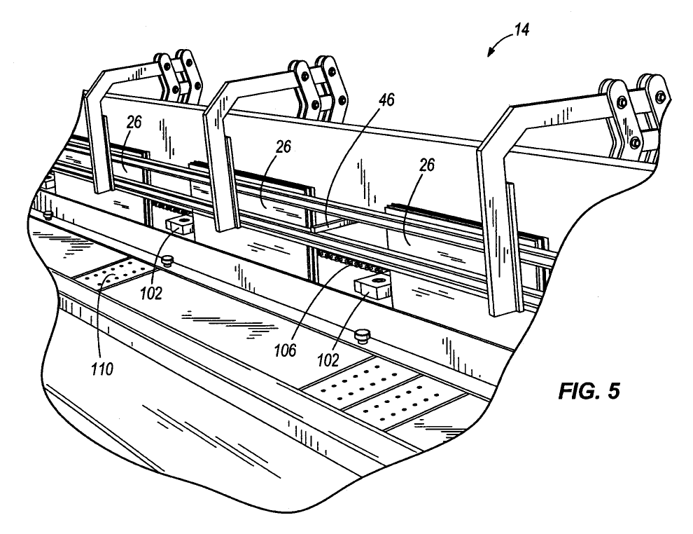

FIGS. 1-4 illustrate one embodiment of an alignment device 10 for use with a book binder 14 (FIG. 5). The alignment device 10 is operable to contact and engage signatures 18 that have shifted beyond an edge (e.g., a leading edge 22) of a book block 26 and move the signatures 18 back into the book block 26. That is, the alignment device 10 provides a means for applying pressure (e.g., positive pressure) to the signatures 18 to substantially align the signatures 18 of the book block 26. In the illustrated embodiment, the alignment device 10 includes three pulleys 30, 34, 38, a belt 42 engaging and surrounding the pulleys 30, 34, 38, three fingers 46 coupled to the belt 42, and an actuator 50 coupled to the first pulley 30. The illustrated alignment device 10 is arranged in a generally triangular shape. In other embodiments, the alignment device 10 may include fewer or more pulleys and/or fingers 46. Additionally or alternatively, the alignment device 10 may be arranged in a generally circular, rectangular, oblong, or irregular shape. Furthermore, the fingers 46 may be replaced by brushes, bristles, combs, tabs, or the like.

In other embodiments, the alignment device may alternatively include three sprockets, a chain engaging and surrounding the sprockets, and lugs extending outwardly from the chain. The sprockets and the pulleys 30, 34, 38 (i.e., transmit members) function in a similar manner to transmit power to the chain and the belt 42 (i.e., a loop member), respectively. The lugs may be rigidly or pivotally coupled to the chain to function in a similar manner as the fingers 46.

In still other embodiments, the alignment device may alternatively include an actuator and a plate coupled to the actuator. The actuator may be actuable to slide the plate into and out of a travel path of the book blocks. The plate may slide into the path from either side, the top, or the bottom of the book binder. Additionally, the plate may be coupled to a belt, chain, cable, wire, or other loop member to facilitate movement of the plate in generally the same direction as the book blocks, but at a slower speed or in an opposite direction than the book blocks.

In the non-limiting illustrative embodiment, the alignment device 10 is mounted between an upper plate 54 and a lower plate 58 that are spaced apart from each other and secured together via supports 62. The plates 54, 58 support and protect the alignment device 10 while still allowing a portion of the alignment device 10 (e.g., the fingers 46) to extend outwardly beyond a perimeter 66 of the plates 54, 58. A pair of bracket assemblies 70 connected to the lower plate 58 facilitates attachment and positioning of the alignment device 10 on the book binder 14.

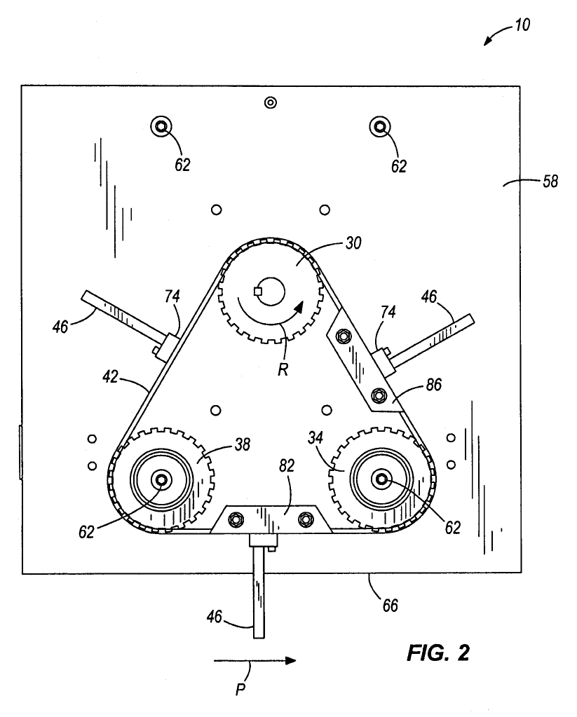

The second and third pulleys 34, 38, or idlers, are spaced apart from the first pulley 30, or driver, and from each other such that the pulleys 30, 34, 38 are arranged in a generally triangular shape. The first pulley 30 is coupled to the actuator 50, or motor, positioned below the lower plate 58. The actuator 50 rotates the first pulley 30 in a direction R to drive the belt 42, and thereby the fingers 46. As shown in FIG. 2, the second and third pulleys 34, 38 are arranged such that, when the first pulley 30 is rotated, the portion of the belt 42 between the second and third pulleys 34, 38 moves in generally the same direction as a path P of the book blocks 26. Although the pulleys 30, 34, 38 are shown oriented in a particular configuration, it should be readily apparent that the configuration may be altered such that, for example, either the second pulley 34 or the third pulley 38 is driven by the motor 50, or that the alignment device 10 could be rotated such that a different portion of the belt 42 moves adjacent the book block path P.

The belt 42 engages the first, second, and third pulleys 30, 34, 38 to rotate about the pulleys 30, 34, 38 in the generally triangular shape. The belt 42 is coupled to the fingers 46 to transmit rotation of the first pulley 30 from the actuator 50 into generally linear movement of the fingers 46. In some embodiments, the pulleys 30, 34, 38 may be replaced by sprockets and the belt 42 may be replaced by a chain, or the belt 42 and the fingers 46 may be moved about fewer or more pulleys. Alternatively, the pulleys 30, 34, 38 may be driven by a timing belt, or the fingers 46 may be independently driven.

The fingers 46, or projections, contact one or more signatures 18 protruding from the leading edge 22 of a book block 26 to push the signatures 18 into the book block 26. As used herein, the term “leading edge” refers to a theoretical downstream edge of the book block 26 defined by the downstream edges of the plurality of signatures that make up the book block 26 if the signatures were all substantially the same size and the upstream edges of the signatures were all substantially aligned with each other against a surface (e.g., a pusher mechanism). The illustrated fingers 46 may be composed of a flexible material (e.g., low durometer urethane) or have other physical properties such that the fingers 46 bend or flex out of the way when the book block 26 contacts one of the fingers 46. In the illustrated embodiment, the fingers 46 are coupled to the belt 42 by mounts 74 and extend outwardly from the belt 42. As shown in FIG. 2, the fingers 46 are equally spaced along the belt 42. For example, in one embodiment, the fingers 46 may be spaced about twelve inches apart. In other embodiments, the fingers 46 may be spaced apart by a different amount or may be unequally spaced along the belt 42. In addition, the illustrated fingers 46 are an elongated cuboid shape such that each finger 46 includes a flat surface 78 or side that contacts the signature(s) 18 protruding from the book block 26. However, the fingers 46 may be configured as a different shape such as, for example, a cylinder, a pyramid, an irregular shape, or the like.

In some embodiments, the alignment device 10 may be configured to account for different size (e.g., length) book blocks. In such embodiments, the actuator 50 may be, for example, a servo motor or drive unit that can adjust the position of the fingers 46 relative to a book block by applying a burst of acceleration or deceleration to the pulleys 30, 34, 38 and the belt 42. For example, for a relatively longer book block, the actuator 50 may apply a burst of acceleration to position the corresponding finger 46 further downstream. For a relatively shorter book block, the actuator 50 may apply a burst of deceleration to position the corresponding finger 46 further upstream. In some embodiments, the varying sizes of the book blocks may be hard-coded into the drive unit, or may be determined in real time with, for example, one or more optical sensors.

Since the fingers 46 project outwardly from the belt 42, the fingers 46 speed up or accelerate when moving around corners (i.e., around the pulleys 30, 34, 38). In this illustrative embodiment, the fingers 46 speed up or accelerate around each of the corners of the triangular shape of the alignment device 10. Such an arrangement allows the fingers 46 to quickly move out of and into the path P as the fingers 46 come around the second and third pulleys 34, 38, respectively. In other embodiments, the radius of each pulley 30, 34, 38 may be adjusted to alter the speed at which the fingers 46 move into and out of the path P.

As shown in FIGS. 1 and 2, the alignment device 10 may also include a first guide 82 and a second guide 86. The first guide 82 may be positioned between the second pulley 34 and the third pulley 36, and the second guide 86 may be positioned between the first pulley 30 and the second pulley 34. In this embodiment, each guide 82, 86 includes a generally C-shaped channel 90 configured to receive a portion of the belt 42. The guides 82, 86 support the belt 42 such that the fingers 46 extend perpendicularly from the belt 42. That is, the fingers 46 extend transversely to the leading edge 22 of the book block 26 traveling along the path P. In the embodiment shown in FIGS. 1-4, a guide is not positioned between the first and third pulleys 30, 38, allowing the belt 42 to flex in this area. Alternatively, the second guide 86 may be moved between the first and third pulleys 30, 38 or may be omitted entirely to allow the belt 42 to flex in a different area.

FIG. 5 illustrates the book binder 14 for use with the alignment device 10. In the illustrated embodiment, the book binder 14 is a perfect binder, and a gathering section 94 of the perfect binder is shown. However, it should be readily apparent that the book binder 14 may alternatively be a saddle stitcher. FIGS. 6A and 6B show a backside of the gathering section 94 to illustrate the relative positioning of the alignment device 10 on the book binder 14. In the illustrated embodiment, the alignment device 10 is enclosed within a housing 98 and only the upper plate 54 is visible.

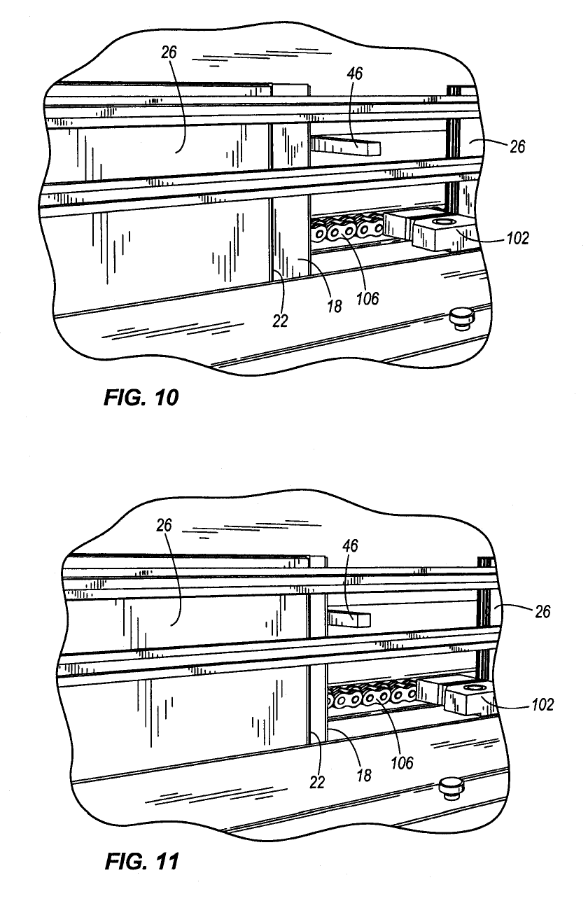

Referring back to FIG. 5, the book binder 14 may include a gatherer pin 102 coupled to a chain 106 (FIGS. 10-12). Alternatively, other suitable types of pusher mechanisms or means for conveying the book block along the path may be used instead of the gatherer pin 102. For example, in other embodiments, the pusher mechanism may comprise a gripper operable to engage and push or pull a book block, a tray operable to carry a book block, or one or more pusher fingers. In addition, the pusher mechanism may include a pin or a stop traveling upstream of the gripper or the tray and adjacent to the book block to facilitate alignment, or substantial alignment, of the signatures of the book block. As such, the pusher mechanism provides a means for conveying a book block along a path and/or a means for providing a contact point against which the projection of the alignment mechanism can force the book block.

The gatherer pin 102 contacts the book block 26 and conveys the book block 26 along the path P. In the illustrated embodiment, the gathering section 94 is slightly inclined to facilitate alignment of the signatures 18 against the gathering pin 102 and joggers are positioned under a portion 110 of the gathering section 94, although these elements are not required. The joggers jog or vibrate the book blocks 26 to further facilitate alignment of the signatures 18 of the book blocks 26. One finger 46 of the alignment device 10 is shown extending across a portion of the book block path to contact and push any signatures 18 that may protrude beyond the leading edge 22 of the book block 26 toward the corresponding gatherer pin 102.

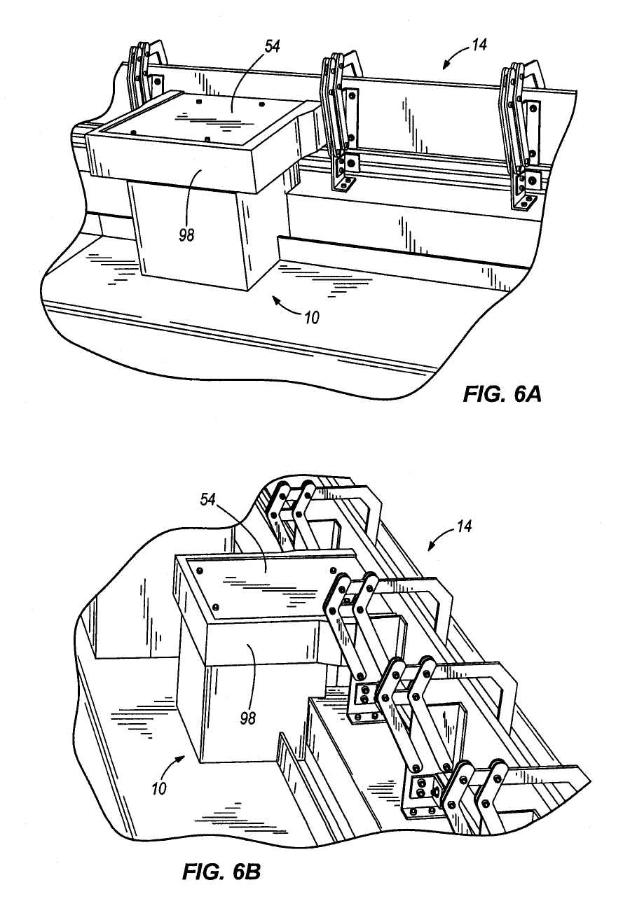

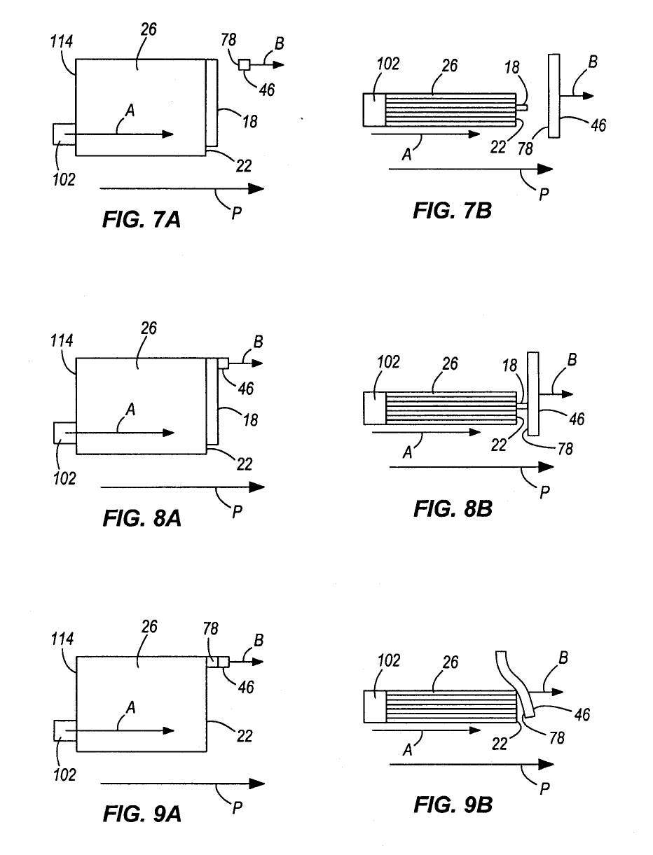

FIGS. 7A-13 illustrate the operation of an embodiment of the alignment device 10. In operation, the gatherer pin 102 contacts a trailing edge 114 of the book block 26 and conveys the book block 26 through the gathering section 94 along the path P. As shown in FIGS. 7A-9B, the gatherer pin 102 conveys the book block 26 at a first speed A. As the book block 26 is conveyed through the gathering section 94. One or more joggers may jog the signatures of the book block 26. However, one or more of the signatures 18 may be left protruding past the leading edge 22 of the book block 26.

While the book block 26 is being conveyed through the gathering section 94, the actuator 50 rotates the first pulley 30 to drive the belt 42 and thereby move the fingers 46 about the pulleys 30, 34, 38. When one of the fingers 46 is traveling between the second and third pulleys 34, 38, the finger 46 extends outwardly past the perimeter 66 of the plates 54, 58 and moves in a generally linear direction along the path P. As shown in FIGS. 7A-9B, the first pulley 30 is rotated at a preset speed such that the fingers 46 travel at a second speed B which is less than the first speed A. The difference in the speeds A, B allows the book block 26 to catch-up to the finger 46 such that the finger 46 may contact and apply a positive pressure to any protruding signatures 18.

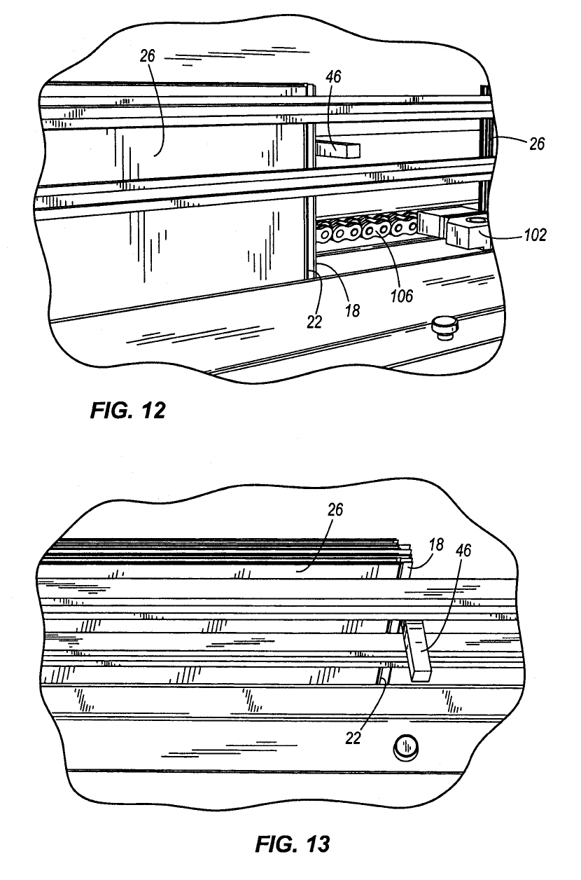

Referring to FIGS. 7A, 7B, and 10, the gatherer pin 102 conveys the book block 26 along the path P at the first speed A, and the finger 46 moves along the path P at the second speed B. Since the book block 26 is moving faster than the finger 46, the book block 26 reaches the finger 46, causing the finger 46 to contact the protruding signature(s) 18, as shown in FIGS. 8A, 8B and 11. The gatherer pin 102 continues to convey the book block 26 toward the finger 46, causing the finger 46 to push the protruding signature(s) 18 toward the gatherer pin 102 and into the book block 26, as shown in FIGS. 12 and 13. Once the signature(s) 18 are pushed back against the gatherer pin 102, the leading edge 22 of the book block 26 begins to engage the finger 46. As shown in FIGS. 9A and 9B, if the finger 46 has not yet rounded the second pulley 34, the finger 46 flexes or bends out of the way, allowing the book block 26 to continue through the gathering section 94 without being stopped or substantially interrupted.

While the illustrated finger 46 contacts the leading edge 22 of the illustrated book block 26, another finger on the belt 42 comes around the third pulley 38 and begins to travel along the path P. This second finger is configured to engage protruding signature(s) from a book block directly upstream of the illustrated book block 26. In this way, the alignment device 10 continually moves the fingers 46 into and out of the path P such that each subsequent book block 26 that is conveyed by a corresponding gatherer pin 102 contacts one of the fingers 46. The alignment device 10 thereby reduces the number of bad book block registrations by pushing any signatures that may have shifted beyond a leading edge of a book block back toward the corresponding gatherer pin.

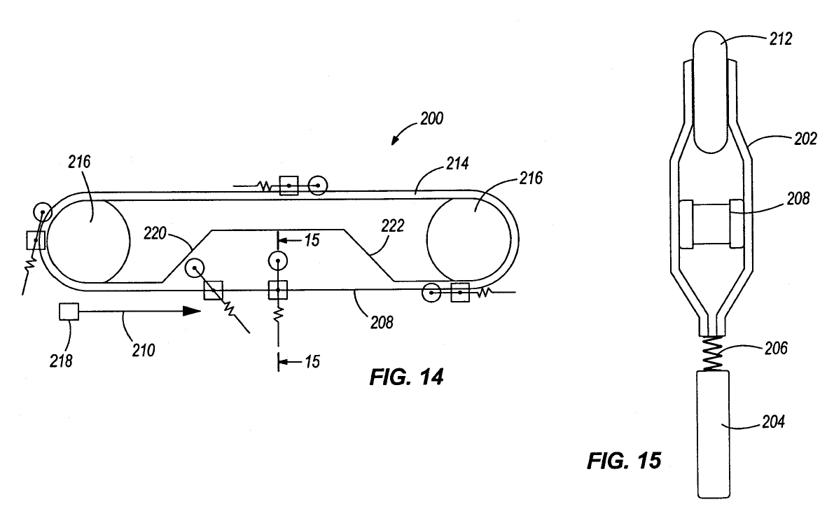

An alignment device 200 according to another embodiment of the invention is illustrated in FIGS. 14 and 15. The alignment device 200 includes a pivoting link 202, a projection 204 connected to the link 202 with a spring 206, and a roller 212 rotatably coupled to the link 202. The link 202 is pivotably attached to a chain 208 or belt and biased toward an extended position by a spring (not shown). The projection 204 is rotated into and out of the book block path 210 through the contact of the roller 212 with a stationary track 214. The chain 208 is driven by sprockets 216. The speed of the chain 208 is slightly slower than a gatherer pin 218 to achieve the same alignment function as the embodiment described with respect to FIGS. 1-13.

FIG. 14 illustrates a single link 202 during different stages of operation. During operation, the link 202 pivots the projection 204 into the path 210 when the roller 212 moves along the extension ramp 220. The link 202 remains biased in the extended position until the link 202 pivots the projection 204 out of the path 210 where the roller 212 moves along the retraction ramp 222. The link 202 maintains the projection 204 in a retracted position as the roller 212 moves around the sprockets 216 and the far side of the guide 214.

While the detailed drawings, specific examples and particular formulations given describe preferred and exemplary embodiments, they serve the purpose of illustration only. The embodiments disclosed are not limited to the specific forms shown. For example, the methods may be performed in any of a variety of sequence of steps. The systems and methods depicted and described are not limited to the precise details and conditions disclosed. Furthermore, other substitutions, modifications, changes, and omissions may be made in the design, operating conditions, and arrangement of the exemplary embodiments without departing from the scope of the invention as expressed in the appended claims.

What is claimed is:

1. An alignment device for substantially aligning a plurality of signatures of a book block, the alignment device comprising:
a projection; and
an actuator coupled to the projection, the actuator actuable to move the projection within a path of the book block such that the projection contacts an edge of at least one of the plurality of signatures and position the at least one of the plurality of signatures into substantial alignment with the other signatures of the book block.

2. The alignment device of claim 1, wherein the actuator is actuable to move the projection out of the path such that the book block is allowed to pass the projection along the path.

3. The alignment device of claim 1, wherein the book block is moved along the path at a first speed, and wherein the actuator moves the projection along the path at a second speed that is less than the first speed.

4. The alignment device of claim 1, wherein the projection comprises a flexible material.

5. The alignment device of claim 1, further comprising
a first transmit member rotatable by the actuator,
a second transmit member spaced apart from the first transmit member, and
a loop member engaging the first transmit member and the second transmit member for rotation about the first and second transmit members,
wherein the projection is coupled to the loop member for movement therewith.

6. The alignment device of claim 5, wherein the projection is a first projection, and further comprising a second projection and a third projection coupled to the loop member for movement therewith, wherein the actuator is actuable to move the second and third projections within the path such that one of the second and third projections contacts edges of at least one of a plurality of signatures of subsequent book blocks conveyed along the path and position the at least one of the plurality of signatures into substantial alignment with the other signatures of the subsequent book blocks.

7. The alignment device of claim 6, wherein the first, second, and third projections are substantially equally spaced along the loop member.

8. The alignment device of claim 5, further comprising a third transmit member spaced apart from the first transmit member and the second transmit member, wherein the loop member engages the third transmit member for rotation about the first, second, and third transmit members.

9. The alignment device of claim 8, wherein the first, second, and third transmit members are arranged in a generally triangular shape.

10. The alignment device of claim 5, further comprising a guide positioned between the first transmit member and the second transmit member, wherein the guide engages a portion of the loop member such that the projection extends outwardly from the loop member substantially transverse to the edge of the book block along at least a portion of the path.

11. The alignment device of claim 1, wherein the actuator is a motor.

12. A system for assembling a book block including a plurality of signatures, the system comprising:
a conveyor configured to convey the book block along a path; and
an alignment device including a projection and an actuator coupled to the projection, the actuator actuable to move the projection within the path such that the projection contacts an edge of at least one of the plurality of signatures and position the at least one of the plurality of signatures into substantial alignment with the other signatures of the book block.

13. The system of claim 12, wherein the actuator is actuable to move the projection out of the path such that the book block is allowed to pass the projection along the path.

14. The system of claim 12, wherein the conveyor is configured to convey the book block along the path at a first speed, and wherein the actuator moves the projection along the path at a second speed that is less than the first speed.

15. The system of claim 12, wherein the projection comprises a flexible material.

16. The system of claim 12, wherein the alignment device comprises a first transmit member rotatable by the actuator, a second transmit member spaced apart from the first transmit member, and a loop member engaging the first transmit member and the second transmit member for rotation about the first and second transmit members, and wherein the projection is coupled to the loop member for movement therewith.

17. The system of claim 16, wherein the projection is a first projection and the alignment device comprises a second projection and a third projection coupled to the loop member for movement therewith, and wherein the actuator is actuable to move the second and third projections within the path such that one of the second and third projections contacts edges of at least one of a plurality of signatures of subsequent book blocks conveyed along the path and positions the at least one of the plurality of signatures into substantial alignment with the other signatures of the subsequent book blocks.

18. A method of substantially aligning a plurality of signatures of a book block using an alignment device, the alignment device comprising a projection and an actuator coupled to the projection, the method comprising:
conveying the book block along a path;
moving the projection within the path with the actuator;
contacting an edge of at least one of the plurality of signatures with the projection when the projection is within the path; and
positioning the at least one of the plurality of signatures into substantial alignment with the other signatures of the book block as the projection contacts the edge of the at least one of the plurality of signatures.

19. The method of claim 18, further comprising moving the projection out of the path with the actuator such that the book block is allowed to pass the projection along the path.

20. The method of claim 18, wherein the book block is conveyed along the path at a first speed, and further comprising moving the projection along the path with the actuator at a second speed that is less than the first speed.

21. A method of substantially aligning a plurality of signatures of a book block, the method comprising:
conveying the book block along a path at a first speed;
moving a projection within the path at a second speed; and
contacting an edge of at least one of the plurality of signatures with the projection when the projection is within the path.

22. The method of claim 21, further comprising positioning the at least one of the plurality of signatures into substantial alignment with the other signatures of the book block as the projection contacts the edge of at least one of the plurality of signatures.

23. The method of claim 21, further comprising moving the projection within the path in the same direction as the book block is conveyed.

24. The method of claim 21, wherein the second speed is less than the first speed.
